(19) United States
(12) Patent Application Publication
(10) Pub. No.: US 2003/0088512 A1
(43) Pub. Date: May 8, 2003

(54) COMPUTER METHODS AND SYSTEMS FOR PAYMENT APPLICATIONS

(76) Inventor: ON HOTER-ISHAY, Tel-Aviv (IL)

Correspondence Address: PENNIE & EDMONDS LLP, 1667 K STREET NW, SUITE 1000, WASHINGTON, DC, 20006

(21) Appl. No.: 09/473,117

(22) Filed: Dec. 28, 1999

(51) Int. Cl. G06F 17/60

(52) U.S. Cl. 705/40

(57) ABSTRACT

The preferred computer-implemented method includes the steps of storing a first amount of money from funds of a first party, issuing a unique identifier to the first party, and storing the unique identifier and the first amount. The method further includes the steps of receiving the unique identifier and a request to release a second amount of money from a second party, refusing to release the second amount if the second amount exceeds the first amount, and releasing the second amount to the second party if the second amount is equal or less than the first amount. A computer system for making payments is also provided. The system includes computer electronics and software that implement the above method and other functionality.

### FIELD OF THE INVENTION

The present invention relates to computer technology for payment applications including methods and systems for electronic payments preferably for the use in on-line commerce.

### BACKGROUND OF THE INVENTION

It is well known to provide credit card information over the Internet or phone to merchants in order to purchase goods and services. ATM bank cards can be used for this purpose as well. Such known methods of payment create potential risks of unauthorized parties intercepting the credit card or bank account information during the transactions and fraudulently misusing this information. Communication systems, such as phone/fax lines and the Internet frequently provide unsatisfactory levels of security and therefore are vulnerable to fraud. Since credit and bank cards are usually associated with significant balances, such a misuse can significantly affect consumer's financial well being. Fraud, however, is not the only problem associated with such conventional payment methods. A consumer may, for example, lose a significant amount by mistakenly ordering a wrong product.

These potential risks associated with credit and bank card purchasing are magnified in the growing E-commerce, i.e., business transactions that take place over the Internet. E-commerce companies may not provide sufficient security to ensure that the credit or bank card information is securely protected from unauthorized parties. An E-commerce company itself may inadvertently overcharge a credit or bank card or mislead a user into an unwanted purchase. There is also a possibility of fraud on the part of an Internet site offering goods or services. A consumer seeking to purchase goods or services over the Internet may not have sufficient information regarding specific sites, their integrity, and the level of security provided by them. Moreover, since credit or bank card information usually includes the identity of the owner, his/her privacy can be comprised, e.g., the credit/bank card holder's preferences in purchasing goods and services can be collected and sold to marketing research firms without any consent from the card holder. In addition, a child of the credit/bank card holder can misuse it by purchasing goods and services over the Internet in an imprudent manner.

Consumers are more likely to commit themselves to specific transactions that do not require sharing permanent personal financial information, e.g., a credit/bank card number, with E-commerce companies and facing a risk of a significant loss or at least a substantial inconvenience in the event of fraud. Therefore, it is desirable to provide a system and method that allow consumers to purchase goods and services over the Internet without using credit/bank card information or other permanent financial information, thereby preventing fraud or misuse of such information.

### SUMMARY OF THE INVENTION

Preferably, a consumer wishing to purchase goods or services over the Internet first acquires one or more Assigned Open Payment Reference (AOPR), e.g., unique identifiers, from a bank or other financial institutes. Each AOPR is associated with a predetermined amount of money, which designates a fixed amount or an upper limit. Moreover, each AOPR can be designated to be used only once or multiple times. Each AOPR can also be designated to have a guaranteed amount, an expiration date, a specific usage code or other assigned conditions or restrictions.

Using these AOPRS a consumer can purchase goods and services from E-commerce vendors by presenting the AOPR the over the Internet or other communication methods. After receiving such an AOPR, the E-commerce company forwards it to the bank in order to authenticate it. The authentication process may involve approval or actual payment by the bank. During the authentication process, the bank may check if the purchase amount is greater than the value of the AOPR used for the purchase. If so, it is not authenticated and the transaction does not go forward. Upon authentication by the bank, the E-commerce company proceeds to deliver goods or services purchased by the consumer. It should be noted that the AOPR does not carry any permanent information about the customer and does not subject the customer to a possibility of a significant future loss.

Thus, the preferred system provides a computerized method of making payments without disclosing permanent financial information of customers to E-commerce vendors. The method includes the steps of storing an amount of money from a consumer requesting to generate AOPRs each of which is associated with a predetermined amount of money, issuing the requested AOPRs, and storing the AOPRs and their value in computer memory. The computer memory is configured to enter all or a combination of the following parameters for each AOPR: single or multiple use, any expiration date, any guarantee or any specific use.

Once the consumer receives the AOPRs, then he/she can present them to a commercial establishment for purchase of goods or services. Upon receiving the AOPRs, the commercial establishment then requests to release the amount of the purchase from a bank or another entity administering the AOPRs. This entity may refuse to release the money if the requested amount exceeds the value of the corresponding AOPR. The money is released if the amount is equal or less than the value of the AOPR. After releasing the money, the corresponding AOPR is updated.

Preferably, the system administering the AOPRs stores detailed information associated with each of the AOPRs, which may include consumer's name and the dates on which the identifiers were issued. Thus, preferably, the money is not released and the transaction is not approved if the detailed information received from a vendor is not identical to the corresponding stored detailed information.

### BRIEF DESCRIPTION OF THE DRAWINGS

FIG. 1 is a schematic diagram showing communication among various participants of the preferred payment system;

FIG. 1A is a block diagram of a payment approval system;

FIG. 1B is a flow chart of the steps for issuing AOPRS;

FIG. 1C is a flow chart of the steps for approving a request;

FIG. 1D is a flow chart of the steps for making payments;

FIG. 2 is an example of a summary of assigned open payment references (“AOPRs”) in the first exemplary embodiment;

FIG. 3 is a flowchart of a payment authentication procedure of the first exemplary embodiment;

FIG. 4 is a flowchart of an AOPR generation authentication procedure of the first exemplary embodiment;

FIG. 5 is an example of a summary of AOPRs in the second exemplary embodiment;

FIG. 6 is a flowchart of a payment authentication procedure of the second exemplary embodiment;

FIG. 7 depicts a set of menu options and procedures for an automatic teller machine of the third exemplary embodiment;

FIG. 8 is a flowchart of an AOPR generation authentication procedure of the third exemplary embodiment;

FIG. 9 is a flowchart of a payment authentication procedure of the third exemplary embodiment;

FIG. 10 is an example of a printed AOPR of the fourth exemplary embodiment; and

FIG. 11 is a flowchart of a payment authentication procedure of the fourth exemplary embodiment.

### DETAILED DESCRIPTION OF THE INVENTION

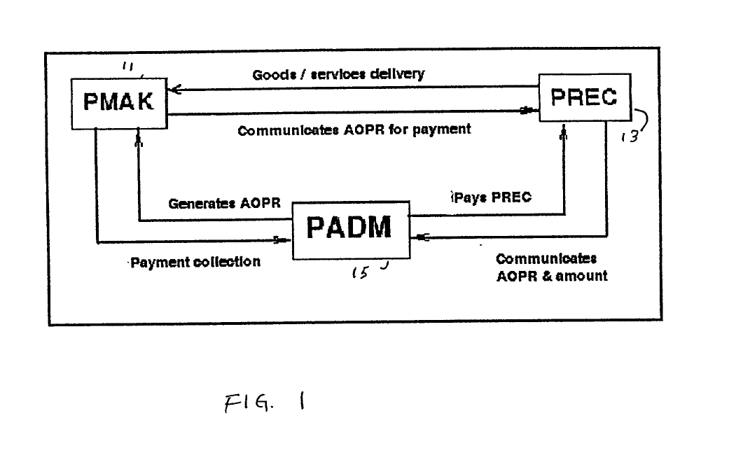

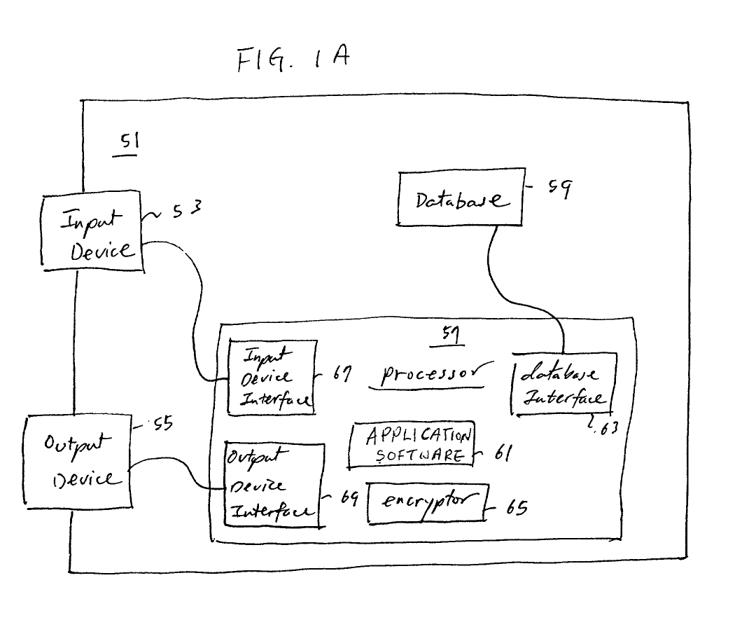

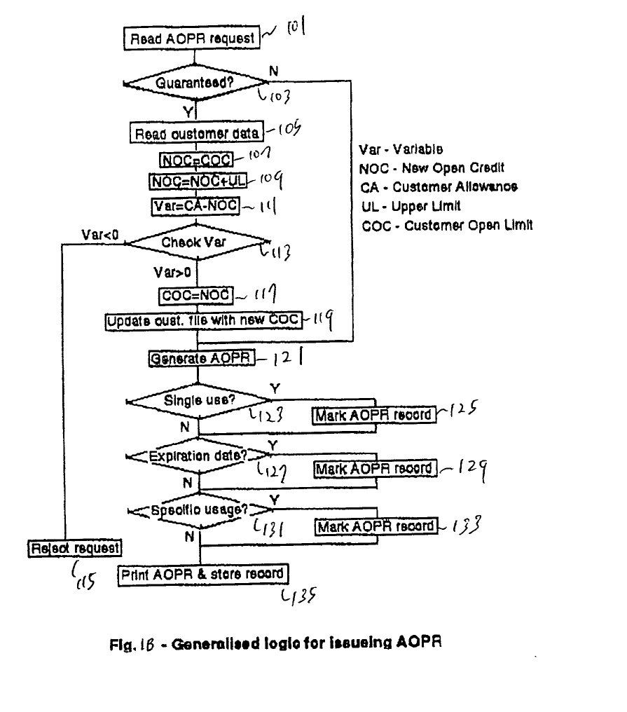

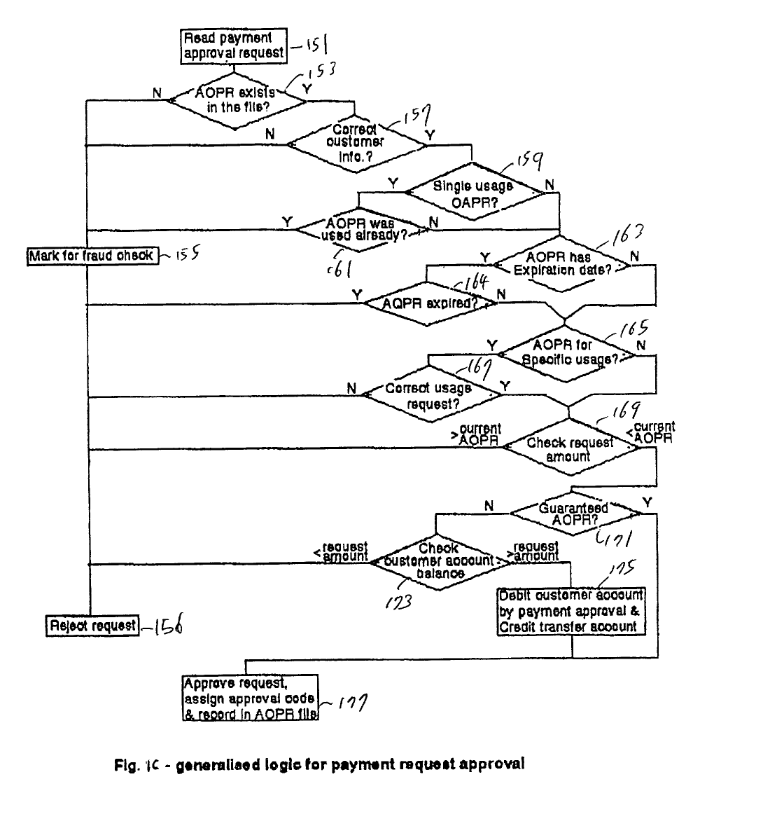

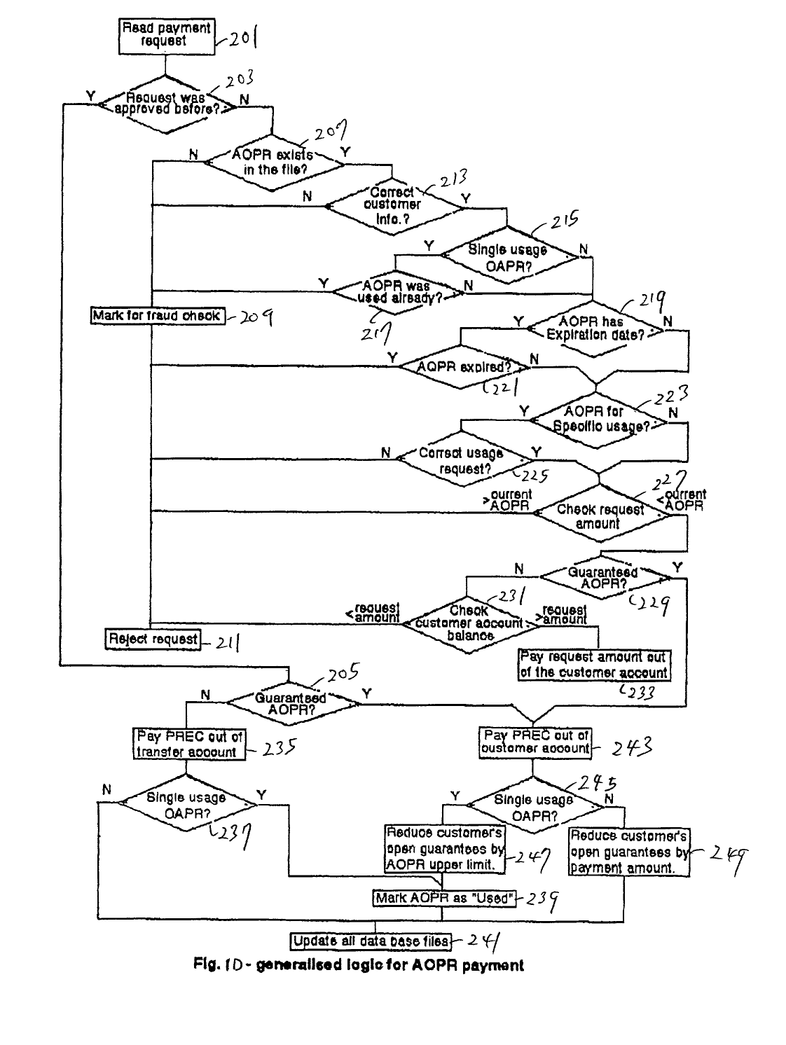

Referring to FIG. 1, three generalized participants of the preferred payment system are a payment maker (PMAK)11, a payment receiver (PREC) 13, and a payment administrator (PADM) 15. The PMAK 11 is typically an individual consumer, but can also be a corporation or any other entity. The PREC 13 is an individual or a company that sells goods or services to consumers, businesses, or any other entities (e.g., an E-commerce company). The PADM 15 is a financial institution or a service organization that administers payment transactions of this invention.

The PADM operates a payment administration system (PAS) 51, for example, such as illustrated in FIG. 1A. The PAS 51 is preferably a computer system that includes an input device 53, an output device 55, a processor 57 with associated software and a database 59. As understood by a person skilled in the art, the identified components are not required to be implemented as separate units, but can be combined in various ways and may include software and hardware. In general, preferably, PAS is implemented as a conventional computer server selected based on performance and implementation takeoffs as known in the art. Also, a network of computers and a special database server may be employed based on performance and implementation takeoffs as known in the art.

The input device 53 is preferably a communication device that can receive electronic messages from remote locations. The input device 53 may also support a scanner with a text recognition system attached thereto, or a keyboard. The output device 55 is preferably a communication device that can forward messages to remote locations. The output device 55 may also support a printer. Preferably, the input and output devices provide communication over the Internet using common communication protocol, such as the Hypertext Markup Language (HTML).

The processor 57 executes software 61 that includes payment applications as discussed subsequently. The preferred system can also include a database interface 63 an input interface 67, an output interface 69, and other software as known in the art. The preferred system can optionally include encryptor 65. The processor 57 is preferably a microprocessor that allows software modules such as described above to run thereon. The encryptor 65 provides secure data encryption capabilities. The input 67 and output 69 device interfaces support communication as known in the art. Other software, as known in the art, such as an operating system runs on the PAS system. Preferably, the PAS system includes all conventional components of an Internet web server. It may, however, also support other communication and storage system capabilities as known in the art such as standard banking systems.

The PAS software modules can also be implemented in a server/client environment or in accordance with a distributed object system such as CORBA as known in the art. In an alternative embodiment, some software functionality can be implemented in an electronic device. For example, the encryptor can be implemented as an encrypting chip. The database 59 can be implemented using conventional database management systems such as ORACLE®, SYBASE® or other similar products. Standard spread sheet software programs may also be used for the database 59. Furthermore, the database 59 can have more than one database to store customer information and AOPR related information on different databases.

One of the functions of the PAS 51 is to generate and issue one or more of Assigned Open Payment References (AOPR). Each AOPR includes a unique identifier, e.g., a unique set of alphanumeric reference symbols, so that the AOPRs are individually identifiable within the relevant database. The uniqueness of the stored AOPR allows tracing and checking payment status of each AOPR. The length and complexity of the unique identifiers can vary for different implementations. An identifier for an issued AOPR is stored in the database 59 by the database interface 63. The uniqueness of the AOPRs is assured by the software running on the PAS. One way to generate a unique AOPR is to generate them randomly and then use only those that are not presently used. Other techniques can also be employed for this purpose as known in the art. The unique identifiers of the AOPRs can be encrypted by the encryptor 65.

In one preferred embodiment, the AOPRs are printed onto a form by the output device 55. In another preferred embodiment, the AOPRs are forwarded to the PMAK 11 electronically. Each AOPR is associated with a monetary value, either a fixed value or an upper limit, expressed in U.S. dollars, or in foreign currency, e.g., British pounds, Euros or any other currency.

Additional information and parameters can be stored in the database 59 for each AOPR such as:

1. Upper limit amount associated with the AOPR;

2. Upper limit amount of accumulated payments when more than one AOPR are issued to a given user;

3. Single/multiple payments options, this field indicates whether or not the issued AOPR can be used only once or multiple times limited by the upper limit amount;

4. Payment guarantee, this field indicates whether or not the AOPR was issued under a payment guarantee by the PMAK;

5. Expiration date of the AOPR;

6. Specific usage, this field indicates whether the AOPR can be used for only a specific purpose;

7. Accounting code for the PADM and/or PMAK; and

8. Status Code such as “1” for created, “2” for used, “3” for in error and “4” for closed AOPRS.

Referring back to FIG. 1, in operation the PADM 15 first issues the AOPRs to the PMAK 11. An example of the logical steps involved in issuing AOPR are illustrated in FIG. 1B. In particular, the PAS first receives or reads AOPR issue requests from the PMAK 11 (step 101). The PAS then determines whether or not the PMAK 11 wishes to have the AOPR to be guaranteed or not (step 103). The PAS then retrieves the PMAK account data from the database (step 105). Subsequently, the PMAK's new open credit (NOC) is set equal to a Customer Open Limit (COL) (step 107), and then an upper limit amount of the AOPR to be issued is added to the NOC (step 109). The PAS further determines whether or not the PMAK's allowance (CA) is less than the PMAK's NOC (step 111). When the NOC is greater than the amount the PMAK is allowed (CA), then the AOPR issue request is denied (step 115). If the NOC amount is less than the CA amount, then the NOC amount is set equal to the COL amount (step 117). The PMAK's database is updated with the new COL amount to be utilized next time the PMAK make another request (step 119). Before the AOPR is issued, the PAS determines whether or not the AOPR is to be a single use AOPR, sets its expiration date, and determined if the AOPR is to have only specific usage (steps 123, 127, 131 respectively). The database is updated accordingly (steps 125, 129, 133). Subsequently, the AOPR is issued (e.g., printed) to the PMAK (step 135). It should be noted that the choice of making the AOPR guaranteed, not guaranteed, single use, multiple use, expiration date, and specific usage are all set by the PMAK.

The guarantee by the PMAK can be made using an existing PMAK's line of credit, savings or checking accounts, or a credit card account with the PADM. It should be noted that whether the AOPR issued is guaranteed or not, the PMAK is not actually charged with the amount of money associated with the issued AOPR. As will be discussed later, the PMAK's accounts are charged or debited only when the AOPR is paid by the PADM.

Once the AOPRs are received by the PMAK 101, he/she can purchase goods and/or services from PREC 103. More specifically, after agreeing upon the amount to be paid for certain goods and services, the PMAK 101 presents the PREC 103 with an AOPR. It is the PMAK's responsibility to ensure that the presented AOPR can meet the agreed transaction parameters. For example, the transaction amount should not be greater than the amount associated with the AOPR. Failing to do so could cause the transaction to be rejected.

After the AOPR is received from the PMAK 101, the PREC 103 makes a request to PADM 105 for approval or payment. When the request for approval is made (instead of making a request for payment) to the PADM, the PAS functions the following steps such as depicted in FIG. 1C. The PAS first receives the request for approval from the PREC (step 151). The PAS then determines whether or not the received AOPR exists in the database (step 153). If no such AOPR exists in the database, then the AOPR is marked to be checked for fraud and the request is rejected (steps 155 and 156 respectively). If such an AOPR exists in the database, then the name of the PMAK provided by the PREC is compared with the PMAK's name associated with the AOPR stored in the database (step 157). If the names do not match, then the AOPR is marked to be checked for fraud and the request is rejected. If the names do match, then whether the AOPR is a single use AOPR or a multiple use AOPR is determined (step 159). When the AOPR received is a single use AOPR, then the PAS further determines whether the received AOPR has been used before (step 161). If the single use AOPR has been used before, then the AOPR is marked to be checked for fraud and the request is rejected. However, if the single use AOPR has not been used before or if the AOPR is a multiple use AOPR, then whether or not the AOPR has been expired is determined (step 163). If the AOPR has been expired, then the request is rejected. If the AOPR has not been expired, the PAS determines whether or not the AOPR is designated to be a specific use AOPR (step 165). If the AOPR is designated as such, then the PAS determines if the AOPR is being used for the designated specific use (step 167). If it is not, then the request is rejected. If the AOPR is not designated for a specific use or the AOPR is correctly used, then the requested amount is compared with the current AOPR amount (step 169). The current AOPR amount is the set value of a single use AOPR or the balance of a multiple use AOPR. If the request amount exceeds the current AOPR amount, then the request is rejected. Otherwise, the PAS determines whether or not the payment of the AOPR is guaranteed (step 171). If the AOPR is a guaranteed, then the request is approved (step 177). If the AOPR is not guaranteed, then the PAS determines whether or not the PMAK's account balance covers the requested amount (step 173). If the balance is sufficient, then the PMAK's account is debited and the request is approved (steps 175 and 177, respectively). If there is insufficient balance in the PMAK's account, then the request is rejected.

In the case of the PREC making a request for payment, the PAS undergoes steps such as illustrated in FIG. 1D. First, the PAS receives a request for payment from the PREC (step 201). The PAS then determines whether the AOPR was approved in a previous request for approval from the same PREC for the instant AOPR (step 203).

If the AOPR was not approved before, then similar steps as described above in connection with the approval process are performed by the PAS (steps from 207 to 233 corresponding to the steps from 153 to 175). However, when the AOPR is guaranteed, the PREC is paid out of the PMAK's account (step 243) and the PMAK's account is reduced accordingly (steps 247 and 249). Further, if the AOPR is a single use AOPR, the AOPR is marked as used (step 239). It should be noted that even if the AOPR is a multiple use AOPR, it can still be marked as used.

Referring back to step 203, if the AOPR was approved before and the AOPR is a guaranteed AOPR, then the PAS performs steps 243 to 249. If the AOPR is not a guaranteed AOPR, then the PREC is paid out of a transfer account (step 235). The PAS further determines if the AOPR is a single use AOPR (steps 237). If so, the AOPR is marked as used (step 239). It should be noted again that even if the AOPR is a multiple use AOPR, it can still be marked as used. After the above steps, the database is updated accordingly (step 241).

In addition to the above described functions of the PAS 151, it may also perform tasks associated with maintaining the database and administration of the system. For instance, the PAS can perform updating records, keeping audits, archiving completed transaction records and other operations as known in the art. Further, depending on the embodiment, there may be other specific tasks, such as marking AOPRs that have expired, re-printing AOPRs that the PMAK lost track of, printing various reports and other operations as understood by a person skilled in the art.

The above described preferred embodiment is further described below in four exemplary embodiments.

I. First Exemplary Embodiment

In the first exemplary embodiment, a retail bank is a PADM. In this embodiment, an individual who is a customer of the bank is a PMAK, and an entity selling goods and services over the Internet, i.e., an E-commerce company, is a PREC. The bank operates a Web site that can transact business over the Internet with bank's customers and E-commerce companies. As known in the art, the bank Web site may include Web pages that can be pulled up by the customers over the Internet. The Web pages are configured to allow the customers to request services from the bank Web site. For example, the bank Web pages can include data entry fields for the customer to request the bank to generate one or more AOPRs with specific upper limits.

The above described Web site can be a part of the PAS maintained and operated by the bank. When the customer sends a request to generate one or more AOPRs using the Web pages described above, the PAS determines whether or not to issue requested AOPRs based on the accuracy of the information provided by the customer. If the request is approved, then the unique identifiers of the AOPRs can be forwarded via the Internet to the customer. It should be noted that the AOPR can be forwarded via telephone, mail, in person or any other standard communication methods.

The PAS of this embodiment preferably stores the following information in its database: AOPR unique identifiers; AOPR status, e.g., “1” designating “created” customer's name, upper limit amount, date issued, customer's account number, E-commerce company's name, E-commerce company's bank code, E-commerce company's bank account, actual amount in the transaction, transaction date, transaction reference, transaction remark, payment date, and customer's bank account number. The fields relating to the E-commerce company are created when the corresponding AOPRs are issued and are filled in later with relevant information when the AOPR is presented by the E-commerce company.

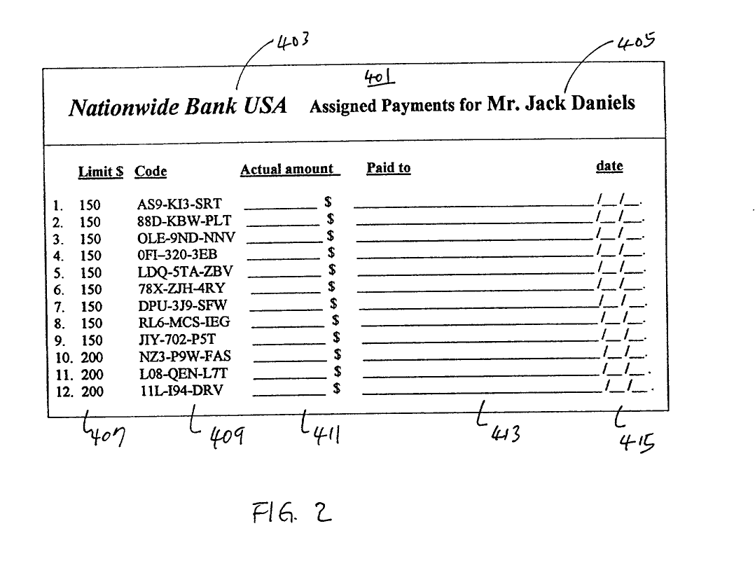

In one embodiment, the PAS can generate and forward an AOPR summary list to the customer. The list contains AOPRs that have been generated for the customer. As shown in FIG. 2, the list includes a header 401 that lists the bank's name 403 and the customer's name 405. Below the header 401, each AOPR line lists the upper limit amount 407, the AOPR unique identifiers 409, and preferably provides a number of fields to enter the actual amount in the transaction 411, the name of the E-commerce company 413, and the transaction date 415. It should be noted that some AOPRs can be used only once and others can be used multiple times until the amount associated with the AOPR is all spent.

As noted, once AOPRs are issued to the customer, they can be used to purchase goods and services offered in E-commerce. In this embodiment, an E-commerce company preferably operates its own Web site. The company's Web site may include a number of Web pages that illustrate its goods and services. Web pages provided by the site allow customers to purchase goods and services offered by the E-commerce company using AOPRs. In particular, such Web pages may include data entry fields to enter the choice of goods and services, one of which is a data field to enter a payment using an AOPR. When the customer chooses that option, a new Web page appears that includes options to enter the following data: payment maker name, payment order reference, i.e., the AOPR unique identifier, and the bank reference. The customer enters such information to complete a purchase.

Subsequently, the E-commerce company prepares and forwards a payment request, or an approval request, to the bank that issued the AOPR. The request may contain all or a combination of the following information: AOPR unique identifiers, customer name, company's name, company's bank code, the company's bank account number, actual transaction amount, transaction date, transaction reference, and any remarks.

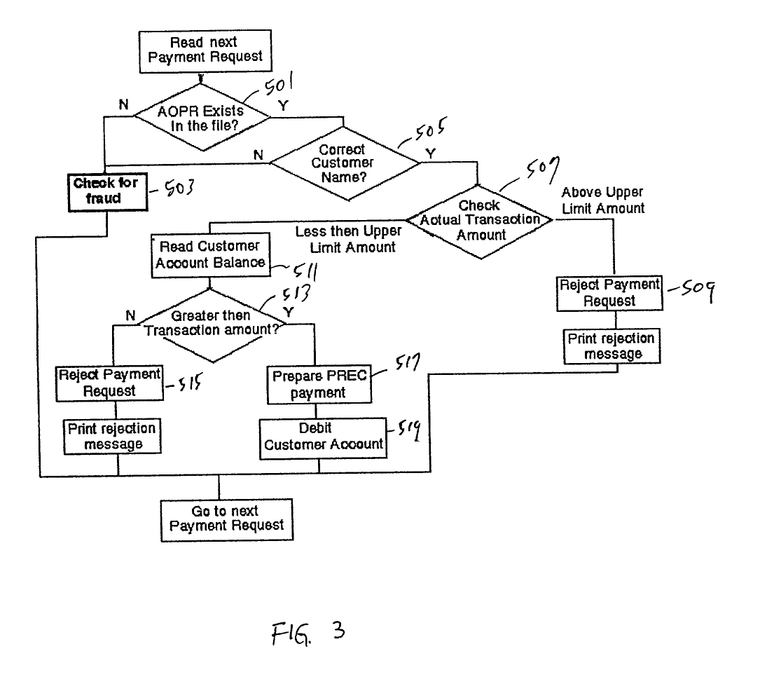

Upon receiving the request, the bank authenticates the AOPR and its amount. If no conflict arises, the bank approves or pays to the E-commerce company. More specifically, referring to FIG. 3, the PAS of this embodiment determines whether the received AOPR exists in its database (step 501) by performing a database search as known in the art. If there is no such AOPR in its database, then the PAS checks for fraud by, for example, contacting the customer to verify information received from the E-commerce company (step 503) and responds to an E-commerce company that the submitted AOPR is invalid and continues to check the next transfer. If the submitted AOPR exists in its database, then the PAS determines if the customer's name is correct (step 505). If the name is incorrect, then again it checks for fraud. If the customer's name is correct, then the PAS compares the actual transaction amount to the upper limit amount associated with that AOPR (step 507). If the actual transaction amount is above the upper limit, the payment request is rejected (step 509). Otherwise, the customer's account is reviewed for the current balance (step 511) to determine whether the current balance associated with the AOPR is more or less than the actual transaction amount (step 513). If the current balance is lower than the actual transaction amount, the request is rejected (step 515). Otherwise, the request is approved. If a payment was requested, then the payment is made to the E-commerce company and the payment amount is debited from the customer's account (steps 517 and 519). Once the payment has been made, or approved, by the bank to the E-commerce company in the requested amount, the E-commerce company delivers the goods and serviced purchased by the customer.

In an alternative embodiment, the payment is made only after comparing the AOPR unique identifiers without checking other information. In yet another embodiment, other information stored in the database can be compared with the information received from the E-commerce company before the amount is paid. As noted, the above approval procedure is performed by the PAS computer system.

The bank may also execute additional tasks associated with the administration of the system as known in the art such as updating records, keeping audits, and archiving completed transaction records. Other routine operations may include re-printing AOPRs that the customer lost track of, printing various reports, following-up on rejected transactions, and maintaining a defaulting suppliers file.

Thus, this system provides a payment mechanism which increases security by limiting the amount associated with a typical AOPR and not disclosing payer's permanent financial information (e.g., credit card number, bank account). This system may also be used securely by children who do not have credit cards to purchase goods and services on the Internet, and who may use this system by paying with AOPRs issued to their parents.

II. Second Exemplary Embodiment

The second exemplary embodiment of the present invention is an extension of the first embodiment described above. More specifically, the bank of the present embodiment provides guaranteed payment options to its customers. In other words, the generation and payment of AOPRs are tied to a guaranteed payment amount provided by the bank to the customer.

In this embodiment, the bank that administers AOPR and E-commerce companies that receive AOPR payments operate a PAS similar to the PAS described in the previous embodiment. When a customer sends a request to generate an AOPR using a Web page operated by the bank, the bank determines based on the information provided by the customer whether or not to issue an AOPR with the requested upper limit. It should be noted that the AOPR can be presented using any other communication methods as described above. The approval procedure at the bank is performed by the PAS of this embodiment.

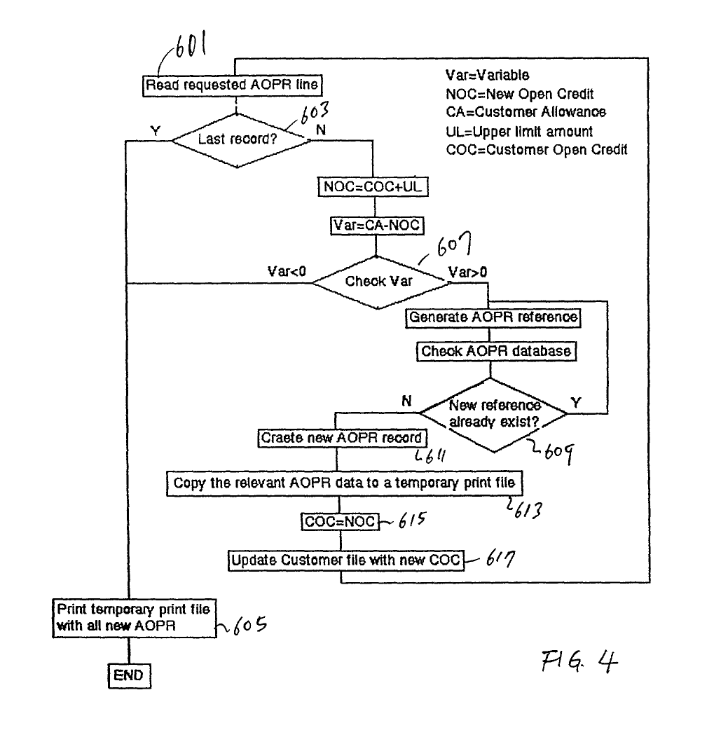

Referring to FIG. 4, the PAS of this embodiment generates the AOPRs in the following manner. First, a request to issue AOPRs is received from the customer (step 601). The AOPRs are generated one at a time. The PAS determines whether it has processed the last AOPR in the customer's request (step 603), and if so, a temporary print file which contains all new AOPRs issued in response to the customer's request is printed (step 605). Otherwise, a new open credit (NOC) for the customer is determined by adding the current open credit of the customer (COC) and the upper limit of the requested AOPR (UL) (see 604). Then, the value (Var) indicating the available funds is computed by subtracting COC computed previously from the customer allowance (total guaranteed funds). If at 607 the calculated value (Var) is less than zero, then a new AOPR is not generated. Otherwise, the new AOPR is generated and the PAS determines whether an identifier of the newly generated AOPR already exists in a database of the PAS (step 609). If it does, another AOPR identifier is generated and the same steps are repeated until the new AOPR identifier is not identical to any of the already generated and currently open AOPRs. Subsequently, a new entry for the new AOPR is created in the database (step 611) and relevant information regarding the AOPR is copied to the temporary print file (step 613). The customer open credit is then set equal to the new open credit (NOC) computed above (step 615). The file associated with the customer is then updated to reflect the new customer open credit amount (step 617).

The newly generated AOPR stored in the database preferably includes the following information: AOPR's unique identifiers, AOPR status, e.g., “1” designating “created”, customer's name, upper limit amount, date issued, and customer bank account. The database also includes the following fields associated with each AOPR: E-commerce company's name where contains AOPR has been used, the E-commerce company's bank code, the E-commerce company's bank account number; actual transaction amount; transaction date; transaction reference, transaction remark, and payment date. This information is stored after the transaction has been completed. The PAS of this embodiment also maintains a customer database that records the following information: customer's name, customer account number (used for payments), guaranteed allowance (i.e., total funds), and the open guaranteed amount (the amount available).

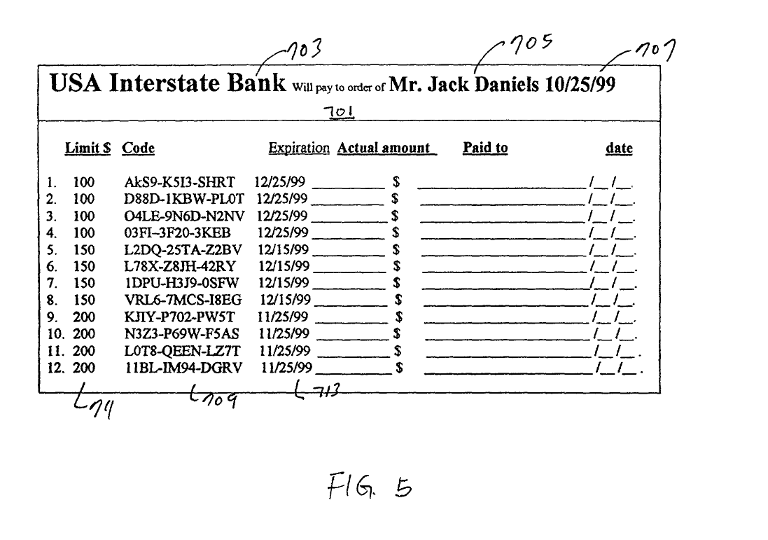

After an AOPR has been approved and stored in the database, the PAS may print an AOPR summary list for the customer. The list may include all the AOPRs that have been generated for the customer. Referring to FIG. 5, the list preferably includes a header 701 and the following fields: bank reference 703, customer name 705, and date issued 707. Each line includes the following information: AOPR unique identifiers 709, upper limit amount 711, expiration date 713 and a number of fields to enter payment data.

When the customer wishes to purchase goods and services on the Internet using AOPRs, transactions that take place between the customer and E-commerce companies are similar to transactions described above in connection with the first exemplary embodiment. Upon completion of such a transaction, E-commerce company forwards the AOPR unique identifier to the bank and the actual transaction amount. Also, the E-commerce company may forward information relating to the AOPR such as: the date the AOPR was issued, customer's name, E-commerce company's name, E-commerce company's bank code, E-commerce company's bank account number, transaction date, transaction reference, and related remarks.

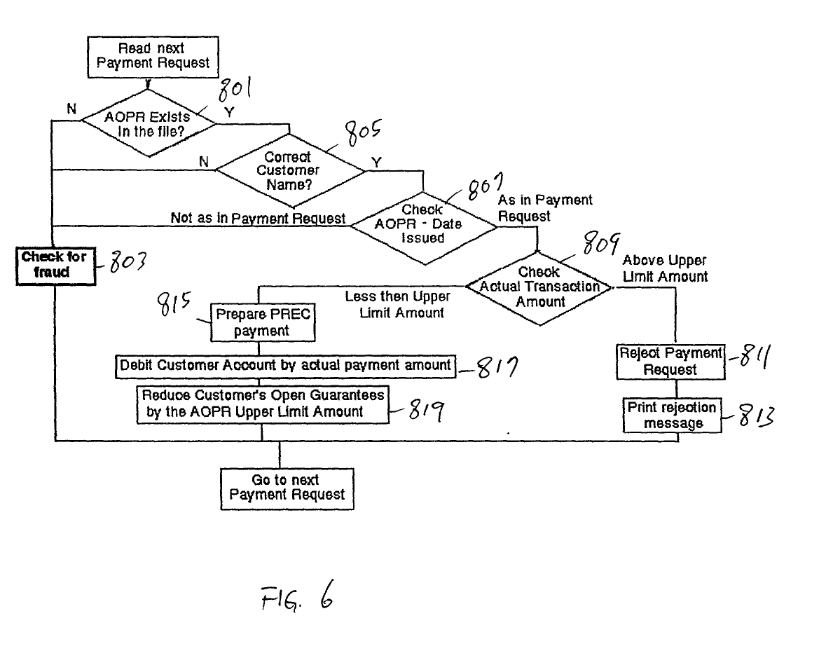

Referring to FIG. 6, upon receiving the request for payment or for approval from an E-commerce company the PAS of this embodiment, determines whether or not the received AOPR exists in the database (step 801). If it does not, then the request is rejected and then can be checked for fraud (step 803) as known in the art. Otherwise, the customer name and the date of issue preferably received along with the payment request are compared respectively with customer's name and the date of issue, recorded in the AOPR database (steps 805 and 807). If any one of these fields does not match, the request is rejected and then can be checked for fraud. Otherwise, the actual transaction amount is compared with the stored upper limit amount for the AOPR (step 809). If the actual transaction amount is above the upper limit amount, then the payment request is rejected and an appropriate rejection message is sent to the E-commerce company (PREC) and printed (step 811 and 813). Otherwise, the requested payment is paid to the PREC (step 815). The customer's account is then debited by the actual payment amount and the customer's open guarantee is reduced by the AOPR's Upper limit amount (steps 817 and 819).

In an alternative embodiment, the payment is made only after comparing the AOPRs' unique identifiers without checking other information. In yet another embodiment, other information stored in the database, e.g., the name of the customer and the date on which the AOPR was issued, can be compared with the information received from the E-commerce company before the payment is made.

The bank may also perform additional tasks associated with the administration of the system: updating records, keeping audits, archiving completed transaction records as known in the art. Other routine operations may include marking expired AOPR records, re-printing AOPRs that the customer lost track of and printing various reports. Additional tasks may also include following-up rejected transactions and maintaining a defaulting suppliers file.

III. Third Exemplary Embodiment

In this embodiment PMAK is a credit card holder wishing to obtain one or more AOPRs preferably from an Automatic Teller Machine (ATM) terminal operated by a bank or financial institution (PADM). Once AOPRs are generated, the PMAK can purchase goods and services preferably from an E-commerce company (PREC) over the Internet or from other sources.

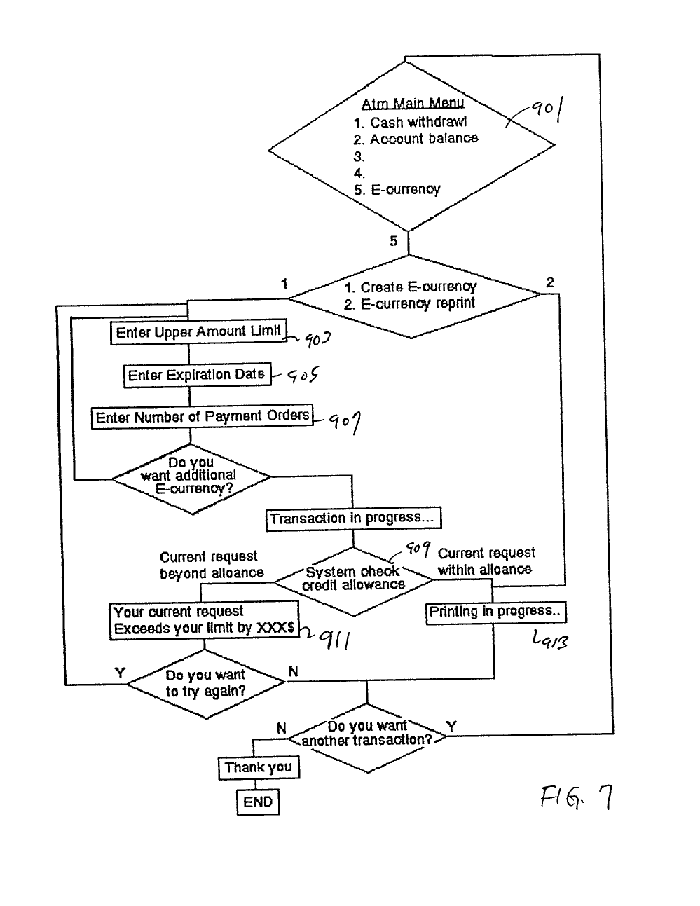

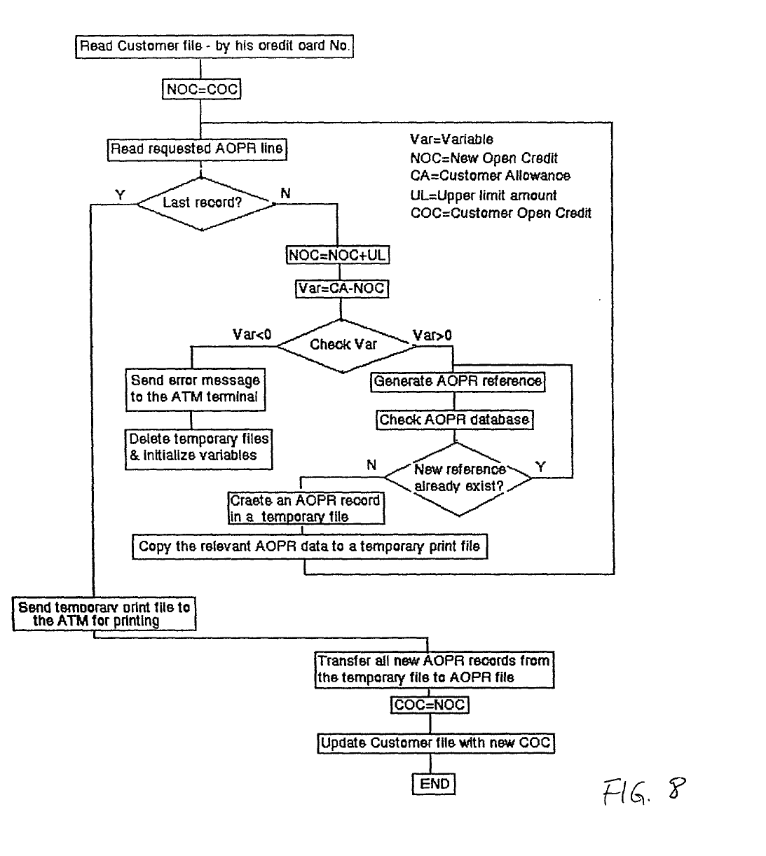

Referring to FIG. 7, preferably, ATM menu 901 appears when a customer wishing to receive one or more AOPRS inserts a credit card into the ATM and enters the corresponding Personal Identification Number (PIN). (Similar processing would be used for a bank card instead of a credit card). The main menu provides an option to select an “E-payment functions” option. When such a option is selected, the ATM menu then asks the PMAK to enter an upper limit amount 903, an expiration date 905, and the desired number of AOPRs, see 907. The information entered by the customer is then transferred to the PAS of this embodiment. The PAS approves the transaction when it determines that the sum of all upper limit amounts for the requested AOPRs is less than or equal to the credit limit allowed for the customer (steps 909, 911 and 913). In the event of a customer who has a bank account and is using a bank card, the approval is based on his/her available balance and/or credit allowance. The PAS performs an approval procedure as depicted in FIG. 8 which is substantially identical to the approval procedure described in connection with FIG. 4, except that in FIG. 8 some of the steps are performed by the ATM.

Upon approval by the PAS, the ATM prints an AOPR summary list which shows all the generated AOPRs. This list is substantially similar to the summary list of FIG. 5. In addition, the PAS records each generated AOPR along with the following information: AOPRs' unique identifiers, each AOPR status (“1” designating “created”), customer's name, upper limit amount, date issued, and customer credit card number (or bank account number).

The PAS is typically located remotely from the ATM in a central location and communicates with several ATMs. A part of the PAS functions can be delegated to the ATM. The printed AOPR should include a remark that the AOPR is subject to further approval. If the ATM is functioning off-line. The information from the ATM is transferred to the bank following the normally used procedure for transforming ATM data. Should there be any conflict among the generated AOPR unique identifiers or should the customer overcharge his/her credit card limit, the issued AOPRs are canceled and an appropriate message is sent to the customer.

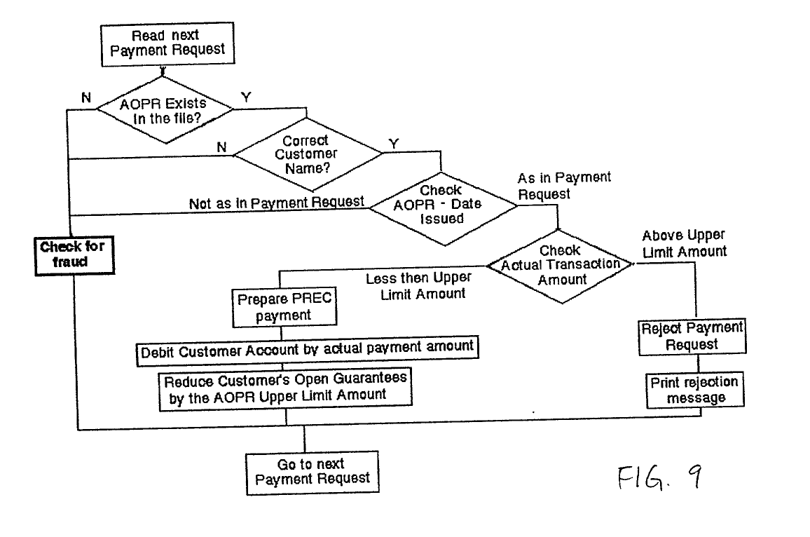

The AOPRs can be used to purchase goods and services on the Internet provided by E-commerce companies. The PAS of this embodiment also performs an authentication procedure as illustrated in FIG. 9 to approve payments on AOPRs. This authentication procedure is substantially identical to the one described in connection with FIG. 6 above.

IV. Fourth Exemplary Embodiment

The fourth exemplary embodiment is designed for a transportation company having a number of vehicles for servicing a wide area. In this embodiment, the transportation company is a PADM, drivers for the transportation company are PMAKs, and a group of gas stations having a prior agreement with the transportation company to accept AOPRs issued by the transportation company is a PREC. The drivers employed by the transportation company receive a booklet of printed AOPRs. The drivers can use the AOPRs as payments at gas stations when purchasing fuel.

In particular, when a PAS operated by the transportation company generates a new AOPR, the new database entry is created that preferably includes the following information: AOPRs' unique identifiers, the AOPR status (e.g., “1” designating “created”), driver's identification and AOPR's upper limit. The database can also include the following data for each AOPR: vehicle license number, purchased gasoline quantity, filling ticket number, filling ticket dollar amount, filling station reference number, date of purchase, hour of purchase, mileage of the vehicle, and AOPR upper limit. The filling ticket number, filling ticket dollar amount and filling station reference number are provided by the gas station where an AOPR is used.

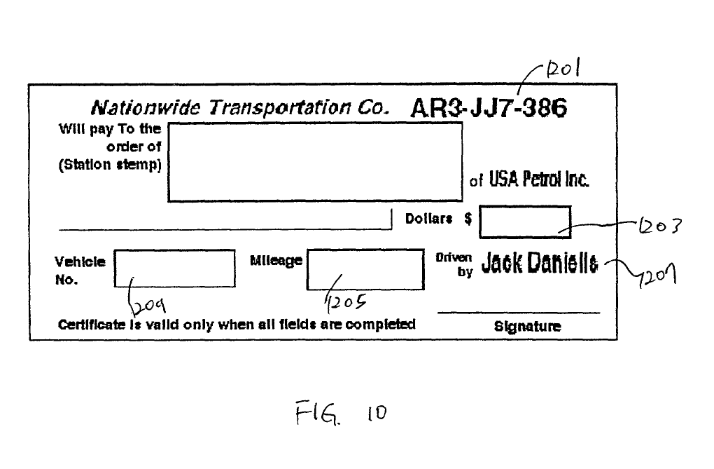

In this embodiment, a number of AOPRs are printed and made into a booklet by an output device of the PAS. Each booklet is assigned to a specific driver. An example of such an AOPR is depicted in FIG. 10, which shows an exemplary AOPR's unique identifier 1201 and boxes for driver's name 1207, vehicle number of the driver 1209 and AOPR upper limit 1203. This information is a subset of the database fields discussed above. Therefore, once the database is properly populated with required information, the AOPR booklets can be printed based on the information stored in the database.

After a booklet of AOPRs has been generated and issued to the named driver, the driver can present an AOPR in the booklet to an attendant in one of the gas stations agreed to accept the AOPRs from the transportation company. In using the AOPR, the driver and the attendant fill out relevant portions of the printed AOPR, such as the driver identification, the name of the gas station, fuel amount, etc. (see FIG. 10). Each AOPR can be used to purchase fuels up to the amount associated thereof. The printed AOPRs are provided for convenience of the driver so that the driver can present only the AOPR unique identifiers to the gas station attendants to purchase fuel.

When the driver uses all the AOPRs in a booklet, he/she returns the empty booklet with the attached filling tickets to the transportation company. Additional information from the filling tickets is then entered to the relevant fields of the AOPR stored data, i.e., fuel amount, filling ticket number, filling ticket amount, filling station reference number, date, hour and etc. The AOPR status is then changed from 1 to 2 (indicating used).

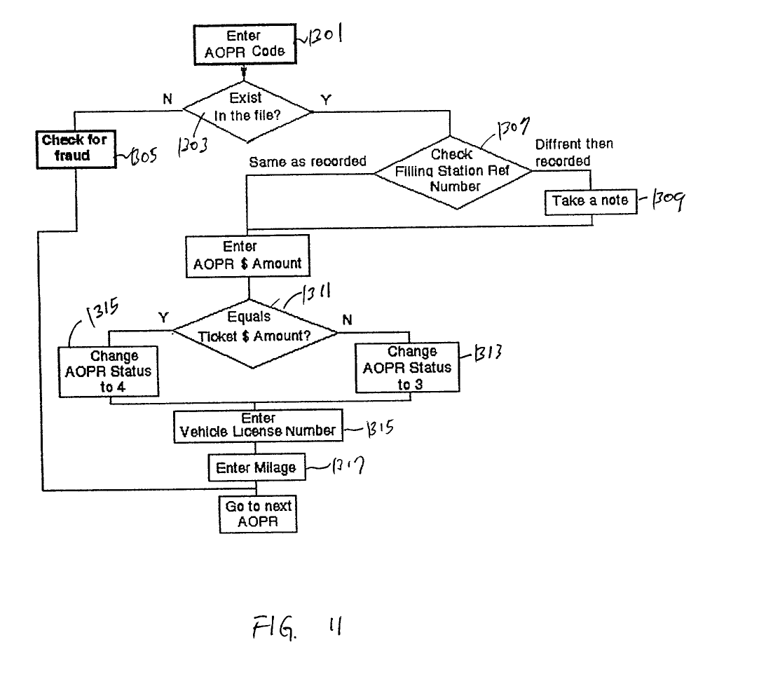

FIG. 11 illustrates the steps taken by the PAS of this embodiment when a used AOPR is received by the transportation company. The information written on the received AOPRs is entered to the PAS manually, i.e., by typing, or it can be entered automatically by a scanner and an automatic text conversion program.

Subsequently, the PAS of this embodiment determines whether the AOPR entered to the PAS matches with the AOPR symbols recorded in its database (step 1303). If the AOPR entered to the PAS does not match with any of the AOPR identifiers stored in the AOPR database, the entry is sent to a security module of the PAS that checks for fraud (step 1305). If the AOPR matches with one of the AOPR identifiers stored in the database, the PAS determines whether the filling station reference number is valid by searching a filling station reference number database (step 1307). If there is no correct match, an error flag is set (step 1309). If the PAS determines that there is a correct match, then the PAS determines whether the entered amount is equal to the amount associated with the AOPR in the database (step 1311). If it does not match, the AOPR Status is changed from 2 to 3 (amount error) (step 1313). Otherwise it is marked as 4 (closed) (step 1315) and the amount is paid to the gas station. After updating the status, the vehicle license number and milage can also be entered to the database (steps 1315 and 1317). If there are more AOPRs to process, the above steps are repeated.

In an alternative embodiment, the payments are made only after checking the authenticity of the AOPR unique identifiers without checking other information. In yet another embodiment, all the other information, e.g., the name of the driver and the date on which the AOPR was used, stored in the database can be compared to the information received from the gas station before the amount is paid to the gas sation.

The database can be used to generate detailed reports on fuel consumption per vehicle, average consumption per mile per vehicle and for the whole fleet, as well as other relevant reports. Once the AOPR is paid, the AOPR unique identifier can be either used again after a certain period, e.g., 1 year, or permanently retired. This embodiment simplifies payments for purchasing gasoline, while tracking gasoline consumption of each vehicle. As understood by a person skilled in the art, the same or similar method can be employed for other applications as well.

The methods of making payments as discussed herein may be applied in any commercial or financial environments. As noted, these methods eliminate the need of disclosing permanent financial details, such as bank account or credit card numbers and limits customer's financial exposure. The payment maker is protected from unwanted disclosure of his/her financial information by the payment receiver and from significant fraudulent or erroneous transactions.

The utilization and verification of the AOPR unique identifiers can be also accomplished by utilizing phone calls among the participants. It should be understood that the software packages and hardware devices described here may be different or modified from the description herein.

The present invention is not to be limited in scope by the specific embodiments described herein. Indeed, modifications of the invention in addition to those described herein will become apparent to those skilled in the art from the foregoing description and accompanying figures. Doubtless, numerous other embodiments can be conceived that would not depart from the teaching of the present invention, whose scope is defined by the following claims.

What is claimed is:

1. A computer-implemented method for making a payment on-line comprising:
storing a first amount of money for a first party;
issuing a unique identifier to the first party;
storing the unique identifier and the first amount in computer memory; and
indicating in the memory whether the unique identifier can be used once or a multiple number of times.

2. The method of claim 1 further comprising:
configuring the computer memory so that the unique identifier is capable of being designated as having a guaranteed payment from the first party.

3. The method of claim 1 further comprising:
configuring the computer memory so that the unique identifier is capable of being used only up to an expiration date.

4. The method of claim 1 further comprising:
receiving the unique identifier from a second party;
receiving one of a request to release and a request to approve a second amount of money from the second party;
refusing the request if the second amount exceeds the first amount; and
granting the request if the second amount is equal or less than the first amount.

5. The method of claim 4 further comprising:
configuring the computer memory so that the unique identifier is capable of being used only under a pre-determined condition.

6. The method of claim 5 wherein the predetermined condition limits the second party to be one specific entity.

7. The method of claim 1 further comprising:
processing information associated with the unique identifier to indicate that it has been used after the step of releasing the second amount; and
refusing to release the second amount when the unique identifier is to be used only once and the unique identifier has already been used once.

8. The method of claim 1 wherein the unique identifier is encrypted.

9. The method of claim 1 further comprising printing the unique identifier on paper.

10. The method of claim 1 wherein the step of storing the first amount of money is achieved by at least one of:
storing a cash payment received from the first party;
storing a bank account of the first party;
storing a credit card account of the first party; and
storing an open credit line of the first party.

11. The method of claim 1 further comprising issuing the unique identifier at an automatic teller machine.

12. The method of claim 1 further comprising issuing the unique identifier over the Internet.

13. The method of claim 1 further comprising storing detailed information associated with the unique identifier, wherein the detailed information includes at least one of the name of the first party, a personal identification number of the first party and the date on which the unique identifier was issued.

14. The method of claim 13 further comprising:
receiving the detailed information from the second party; and
refusing to release the second amount if the stored detailed information is not identical to the received detailed information.

15. A computer-implemented method for making payments comprising:
storing a first amount of money for a first party;
receiving a request from the first party to generate a plurality of identifiers each of which is associated with a second amount of money; and
issuing the requested plurality of unique identifiers to the first party if a sum of the second amounts associated with the identifiers is equal to or less than the first amount;
storing the unique identifiers and the respective second amounts in computer memory; and
indicating in the memory whether the unique identifier can be used once or a multiple number of times.

16. The method of claim 1 further comprising:
configuring the computer memory so that the unique identifier is capable of being used only up to an expiration date.

17. The method of claim 16 further comprising:
receiving one of the plurality of unique identifiers from a second party;
receiving one of a request to release and a request to approve a third amount of money from the second party;
refusing the request if the third amount exceeds the second amount stored for the corresponding unique identifier; and
releasing the requested amount to the second party if the requested amount is equal or less than the second amount stored for the received identifier.

18. The method of claim 17 further comprising:
processing information for the received unique identifier so as to indicate that it has been paid after releasing money requested in connection with the identifier; and
refusing to release the requested amount when the received unique identifier is to be used only once and the unique identifier has already been used once.

19. The method of claim 18 further comprising:
configuring the computer memory so that the unique identifier is capable of being used only under a pre-determined condition.

20. The method of claim 19 wherein the pre-determined condition limits the second party to be one specific entity.

21. The method of claim 15 wherein the unique identifiers are encrypted.

22. The method of claim 15 further comprising printing each of the unique identifiers on an individual piece of paper to be issued to the first party.

23. The method of claim 15 wherein the step of storing the first amount is achieved by at least one of:
storing a cash payment received from the first party;
storing a certain amount from a bank account the first party;
storing a credit card account of the first party; and
storing an open credit line of the first party.

24. The method of claim 15 further comprising issuing the unique identifiers at an automatic teller machine.

25. The method of claim 15 further comprising issuing the unique identifiers over the Internet.

26. The method of claim 15 further comprising storing detailed information associated with each of the unique identifiers, wherein the detailed information includes at least one of the name of the first party, a personal identification number of the first party and the date on which the corresponding unique identifier was issued.

27. The method of claim 26 further comprising:
receiving detailed information for one of the unique identifiers from the second party; and
refusing to release money if the received detailed information is not identical to the corresponding stored detailed information.

28. A computer-implemented system for making payments comprising:
an input device configured to electronically receive a request to generate a unique identifier associated with a first amount of money;
software for storing the first amount of money from funds of a first party;
software configured to issue the requested identifier to the first party;
a database configured to store the unique identifier and the corresponding first amount, the database capable of storing the unique identifier so that the unique identifier can be used only once or multiple times;
wherein the input device is further configured to receive the unique identifier and a request to release a second amount of money from a second party; and
wherein a processor coupled to the input device executes software configured to refuse to release the second amount if the second amount exceeds the first amount stored in connection with the identifier, and configured to release the second amount to the second party if the second amount is equal or less than the first amount.

29. The device of claim 28 wherein the input device provides communication over the Internet.

30. The system of claim 29 wherein
the database is further configured to indicate that the unique identifier has been paid after releasing the second amount; and
software configured to refuse to release the second amount when the unique identifier is to be used only once and the unique identifier has already been used once.

31. The method of claim 28 further comprising:
configuring the computer memory so that the unique identifier is capable of being used only up to an expiration date.

32. The method of claim 28 further comprising:
configuring the computer memory so that the unique identifier is capable of being used only under a pre-determined condition.

33. The method of claim 32 wherein the pre-determined condition limits the second party to be one specific entity.

34. The system of claim 28 wherein the unique identifier is encrypted.

35. The system of claim 28 further comprising an output device configured to print a unique identifier on a piece of paper.

36. The system of claim 29 wherein the communication over the Internet is compatible with a data format of a browser of a user's computer.

37. The system of claim 29 wherein the database is further configured to store detailed information associated with the unique identifier, and wherein the detailed information includes at least one of the name of the first party, a personal identification number of the first party and the date on which the unique identifier was issued.

38. The system of claim 37 wherein
the input device is further configured to receive the detailed information associated with the unique identifier from the second party; and
the processor executes software configured to refuse to release the second amount if the received detailed information is not identical to the corresponding stored detailed information for the identifier.
